(19) United States
(12) Patent Application Publication
(10) Pub. No.: US 2007/0242648 A1
(43) Pub. Date: Oct. 18, 2007

(54) Managing dormant handoffs in radio access networks

(76) Inventors: Deepak Garg, Nashua, NH (US); Douglas Norman Knisely, Wheaton, IL (US)

Correspondence Address: FISH & RICHARDSON PC, P.O. BOX 1022, MINNEAPOLIS, MN, 55440-1022, US

(21) Appl. No.: 11/402,744

(22) Filed: Apr. 12, 2006

(51) Int. Cl. H04Q 7/28

(52) U.S. Cl. 370/341; 370/329

(57) ABSTRACT

In a radio access network including subnets, enabling a radio node of a first subnet to receive a communication over an access channel from an access terminal that is in a dormant state and to send information about the communication to a radio node controller of a second subnet. In a radio access network including a first subnet and a second subnet, the first subnet and the second subnet being neighboring subnets of the network, enabling a radio node of the first subnet to broadcast an overhead message comprising a subnet boundary identifier.

### CROSS-REFERENCE TO RELATED APPLICATIONS

This application is related to U.S. application Ser. Nos. 11/037,896, filed on Jan. 18, 2005, 09/891,103, filed on Jun. 25, 2001, 10/848,597, filed on May 18, 2004, and 11/243,405, filed on Oct. 4, 2005, 11/305,286, filed on Dec. 16, 2005, all of which are incorporated herein by reference.

### BACKGROUND

This description relates to managing dormant handoffs in radio access networks.

High Data Rate (HDR) is an emerging mobile wireless access technology that enables personal broadband Internet services to be accessed anywhere, anytime (see P. Bender, et al., “CDMA/HDR: A Bandwidth-Efficient High-Speed Wireless Data Service for Nomadic Users”, IEEE Communications Magazine, July 2000, and 3GPP2, “Draft Baseline Text for 1xEV-DO,” Aug. 21, 2000). Developed by Qualcomm, HDR is an air interface optimized for Internet Protocol (IP) packet data services that can deliver a shared forward link transmission rate of up to 2.46 Mbit/s per sector using only (1X) 1.25 MHz of spectrum. Compatible with CDMA2000 radio access (TIA/EIA/IS-2001, “Interoperability Specification (IOS) for CDMA2000 Network Access Interfaces,” May 2000) and wireless IP network interfaces (TIA/EIA/TSB-115, “Wireless IP Architecture Based on IETF Protocols,” Jun. 6, 2000, and TIA/EIA/IS-835, “Wireless IP Network Standard,” 3^{rd} Generation Partnership Project 2 (3GPP2), Version 1.0, Jul. 14, 2000), HDR networks can be built entirely on IP technologies, all the way from the mobile Access Terminal (AT) to the global Internet, thus taking full advantage of the scalability, redundancy and low-cost of IP networks.

An EVolution of the current 1xRTT standard for high-speed data-only (DO) services, also known as the 1xEV-DO protocol has been standardized by the Telecommunication Industry Association (TIA) as TIA/EIA/IS-856, “CDMA2000 High Rate Packet Data Air Interface Specification,” 3GPP2 C.S0024-0, Version 4.0, Oct. 25, 2002, which is incorporated herein by reference. Revision A to this specification has been published as TIA/EIA/IS-856, “CDMA2000 High Rate Packet Data Air Interface Specification,” 3GPP2 C.S0024-A, Version 2.0, June 2005, and is also incorporated herein by reference. Revision B to this specification has been initiated as TIA/ELA/IS-856, “CDMA2000 High Rate Packet Data Air Interface Specification,” 3GPP2 C.S0024-B, Version 1.0, March 2006, but has not yet been adopted.

A 1xEV-DO radio access network (RAN) includes access terminals in communication with radio nodes over airlinks. Each access terminal may be a laptop computer, a Personal Digital Assistant (PDA), a dual-mode voice/data handset, or another device, with built-in 1xEV-DO support. The radio nodes are connected to radio node controllers over a backhaul network that can be implemented using a shared IP or metropolitan Ethernet network which supports many-to-many connectivity between the radio nodes and the radio node controllers. The radio access network also includes a packet data serving node, which is a wireless edge router that connects the RAN to the Internet.

The radio node controllers and the radio nodes of the radio access network can be grouped into radio node controller clusters. The footprint of each radio node controller cluster defines a single 1 xEV-DO subnet.

Each radio node has a primary association with the radio node controller in its subnet and may have a border association with a radio node controller in another subnet. Generally, when a radio node has a primary association with a radio node controller, messages can be exchanged over the forward and reverse traffic channels, the control channel, and the access channel. When a radio node has a border association with a radio node controller, messages can be exchanged over the forward and reverse traffic channels, and the control channel. No messages are exchanged over the access channel. Additional information concerning the primary associations between radio nodes and radio node controllers are described in U.S. application Ser. Nos. 11/037,896 filed on Jan. 18, 2005, 09/891,103, filed on Jun. 25, 2001, and 10/848,597, filed on May 18, 2004, and incorporated by reference. Additional information concerning the border associations between radio nodes and radio node controllers are described in U.S. application Ser. Nos. 11/305,286, filed on Dec. 16, 2005, and incorporated by reference.

Typically, in a scenario in which an access terminal crosses over the border from one subnet (“source subnet”) to another subnet (“target subnet”), an A13 dormant handoff is performed between the radio node controllers of the source and target subnets. A dormant handoff is triggered by a receipt of a UATI_Request message sent by an access terminal. The access terminal sends a UATI_Request message when it recognizes that it has crossed-over a subnet border. In some examples, the access terminal monitors the unique 128-bit SectorID of a sector parameter message being broadcasted by each sector. All sectors that belong to the same subnet have SectorIDs that fall within a certain range. The 32-bit UATI (discussed above) assigned to each access terminal by a radio node controller of a particular subnet also falls within this range. When the access terminal moves into the coverage area of another subnet, the access terminal compares its UATI with the SectorID of the sector parameter message being broadcasted by its serving sector. When the UATI and the SectorID do not belong to the same range, the access terminal sends a UATI_Request message over the access channel of its serving radio node, which routes the message to the radio node controller with which it has a primary association (in this case, the radio node controller of the target subnet). The radio node controller responds to the receipt of the UATI_Request message by initiating a dormant handoff with the radio node controller of the source subnet.

Network resources and airlink usage may be wasted when an access terminal's session is repeatedly transferred between multiple radio node controllers as the radio frequency channel conditions sway to favor one serving radio node over another. The service disruption experienced by the access terminal while a dormant handoff is being performed may be significant if the access terminal frequently crosses over the subnet border between different subnets or is located at or near the subnet border.

### SUMMARY

In one aspect, in a radio access network including subnets, a method includes enabling a radio node of a first subnet to receive a communication over an access channel from an access terminal that is in a dormant state and to send information about the communication to a radio node controller of a second subnet.

Implementations can include one or more of the following. At least one sector of the radio node of the first subnet is at or near a geographic boundary of the first subnet. The method for enabling includes providing access by the radio node to a radio node controller identifier for the radio node controller of the second subnet. The radio node controller identifier includes a colorcode. The method of enabling includes providing the radio node of the first subnet with information sufficient to enable the radio node to identify the radio node controller of the second subnet to which the communication is sent. The information includes a radio node controller identifier for each radio node controller with which the radio node of the first subnet has an association. The information includes a radio node colorcode table. The method for enabling includes examining the communication to determine whether its destination is a radio node controller with which the radio node of the first subnet has an enhanced border association.

In one aspect, in a radio access network including a first subnet and a second subnet, the first subnet and the second subnet being neighboring subnets of the network, a method includes enabling a radio node of the first subnet to broadcast an overhead message comprising a subnet boundary identifier.

Implementations can include one or more of the following. The subnet boundary identifier identifies a sector of the radio node as being a border sector or a non-border sector. At least one sector of the radio node of the first subnet is at or near a geographic boundary between the first subnet and the second subnet. The overhead message includes a 1xEV-DO sector parameters message, and the subnet boundary identifier includes one or more bits of a IgnoreSubnetBoundary field. The overhead message further includes a sector identifier. An action is taken by an access terminal having a session on a radio node controller of the second subnet when both the sector identifier identifies the access terminal as being in a coverage area of the first subnet and the subnet boundary identifier identifies a serving sector as being a non-border sector. The action includes sending a Universal Access Terminal Identifier (UATI) Request message of the IS-856 standard through the radio node of the first subnet to the radio node controller of the first subnet. No action is taken by an access terminal having a session on a radio node controller of the second subnet when both the sector identifier identifies the access terminal as being in a coverage area of the first subnet and the subnet boundary identifier identifies a serving sector as being a border sector.

In one aspect, a radio access network includes a first subnet including a first radio node controller and a first radio node, and a second subnet includes a second radio node controller, wherein the first radio node has an association with the second radio node controller that enables the first radio node to receive a communication over an access channel from an access terminal in a dormant state and to send the communication to the second radio node controller.

Implementations can include one or more of the following. The first subnet and the second subnet are neighboring subnets. The first radio node is configured to broadcast an overhead message comprising a subnet boundary identifier. The subnet boundary identifier identifies a sector of the first radio node as being a border sector or a non-border sector. The first radio node has a radio node colorcode table that identifies colorcode assignments for radio node controllers with which the first radio node is associated. The first radio node controller examines the communication received over the access channel from the access terminal in the dormant state, and identifies a destination of the communication based on the examination. The first radio node has an association with the second radio node controller that enables the access terminal to maintain its session on the second radio node controller as the access terminal moves from a coverage area of the second subnet to a first coverage area of the first subnet. The first coverage area of the first subnet comprises a border sector of the first radio node.

In one aspect, in a radio access network including subnets, an apparatus includes means for enabling a radio node of a first subnet to receive a communication over an access channel from an access terminal that is in a dormant state and to send information about the communication to a radio node controller of a second subnet.

Implementations can include one or more of the following. The means for enabling includes means for providing access by the radio node to a radio node controller identifier for the radio node controller of the second subnet. The radio node controller identifier includes a colorcode.

In one aspect, in a radio access network including a first subnet and a second subnet, the first subnet and the second subnet being neighboring subnets of the network, an apparatus includes means for enabling a radio node of the first subnet to broadcast an overhead message comprising a subnet boundary identifier.

Implementations can include one or more of the following. The subnet boundary identifier identifies a sector of the radio node as being a border sector or a non-border sector. At least one sector of the radio node of the first subnet is at or near a geographic boundary between the first subnet and the second subnet. The overhead message includes a 1xEV-DO sector parameters message, and the subnet boundary identifier includes one or more bits of a IgnoreSubnetBoundary field.

Advantages of particular implementations may include one or more of the following. By including radio nodes that have enhanced border associations with radio node controllers of other subnets, an access terminal that is located in an area that straddles the boundaries or borders between two subnets is able to maintain its network connectivity without having its session repeatedly bounce between the radio node controllers of the two subnets. The border sectors and the enhanced border associations enable the access terminal to have a greater range of movement within the footprint of the network before a dormant handoff has to be initiated by a radio node controller. By triggering dormant handoffs to occur only in the event that an access terminal moves beyond a buffer region between two subnets, the frequency at which an access terminal's session is transferred between multiple radio node controllers is reduced. This in turn maximizes the available network resources by not using them for unnecessary session transfers, reduces airlink usage of the radio access network, and minimizes unnecessary session transfers. The user therefore experiences better call setup and less call drops at the subnet border.

Other features and advantages will be apparent from the description and the claims.

### DESCRIPTION OF DRAWINGS

FIGS. 1-2 each show a radio access network.

### DETAILED DESCRIPTION

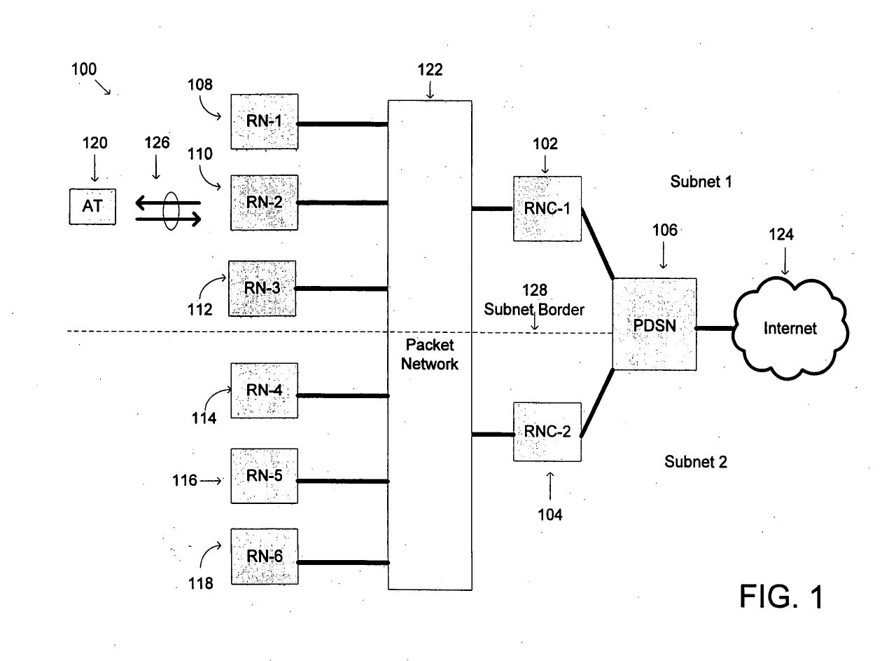

In the example of FIG. 1, a 1xEV-DO radio access network 100 has two subnets (“subnet 1” and “subnet 2”). Subnet 1 has a radio node controller 102 and three radio nodes 108, 110, 112. Subnet 2 has a radio node controller 104 and three radio nodes 114, 116, 118. The radio node controllers 102, 104 are connected to the radio nodes 108, 110, 112, 114, 116, 118 over a packet network 122. The packet network 122 can be implemented as an IP-based network that supports many-to-many connectivity between the radio nodes and the radio node controllers. The packet network is connected to the Internet 124 via a packet data serving node (PDSN) 106. Other radio nodes, radio node controllers, subnets and/or packet networks (not shown in FIG. 1) can be included in the radio access network 100. The packet network 122 may be several distinct networks connecting individual radio node controllers to their associated radio nodes, or it may be a single network as shown in FIG. 1, or a combination.

Each radio node controller 102, 104 is configured to have a primary association with the radio nodes of its subnet. As an example, the radio node controller RNC-1 102 has a primary association with the radio nodes RN-1 108, RN-2 110, RN-3 112. Such a primary association enables the radio node controller RNC-1 102, by way of a sector of a radio node (e.g., RN-1 108), to exchange messages with an access terminal (e.g., access terminal 120) over the forward and reverse traffic channels, the control channel, and the access channel when the access terminal 120 is in the coverage area of the radio node (e.g., RN-1 108).

In some implementations, the network operator further configures the radio node controllers of each subnet to have an enhanced border association with certain radio nodes of the other subnet. Typically, the radio nodes with which a radio node controller has an enhanced border association are geographically located at or near the subnet boundaries. The enhanced border association is an extension of the border association concept described in U.S. application Ser. No. 11/305,286, in that it allows for access channel messages to be communicated from access terminals within a sector of a radio node in one subnet to a radio node controller of another subnet.

Each radio node controller in the radio access network is assigned an 8-bit colorcode (e.g., as defined in the TL1/EIA/IS-856 specification) by the network operator that corresponds to a locally unique identifier of the radio node controller. Although the same 8-bit colorcode can be assigned to multiple radio node controllers in the radio access network, provisions are made to ensure that a particular colorcode is assigned to only one radio node controller per subnet, and not used by any neighboring subnet. In addition, provisions are made to ensure that neighbors of a subnet do not repeat any common colorcode among them.

Each radio node controller includes (or has access to) a colorcode table (“RNC colorcode table”) that identifies the colorcode assignments for all radio node controllers within its subnet, as well as some other radio node controllers that are not members of this subnet. The RNC colorcode table contains, among other things, the IP address of each of the radio node controllers from which it can retrieve a session, e.g., using the A13 protocol. When a radio node controller assigns a new Universal Access Terminal Identifier (UATI) to an access terminal, that radio node controller becomes the access terminal's serving radio node controller on which a 1xEVDO session resides. In some examples, the assigned UATI includes a 32-bit address structure having information in two fields: a colorcode field and a per-user assigned field. The colorcode field includes 8 bits of information that corresponds to the serving radio node controller's assigned colorcode. The per-user assigned field includes 24 bits of information that corresponds to a unique identification of the user session within the radio node controller.

Each radio node includes (or has access to) a colorcode table (“RN colorcode table”) that identifies the colorcode assignments for all of the radio node controllers within its subnet. Some radio nodes further include in their respective RN colorcode tables the colorcode assignments for one or more radio node controllers in one or more other subnets. For example, a RN colorcode table may include the colorcode assignments for the radio node controllers with which the radio node has a primary association or an enhanced border association. The RN colorcode table identifies the radio node controller destination address to send packets (e.g., received from the access terminal) addressed with a particular UATI colorcode.

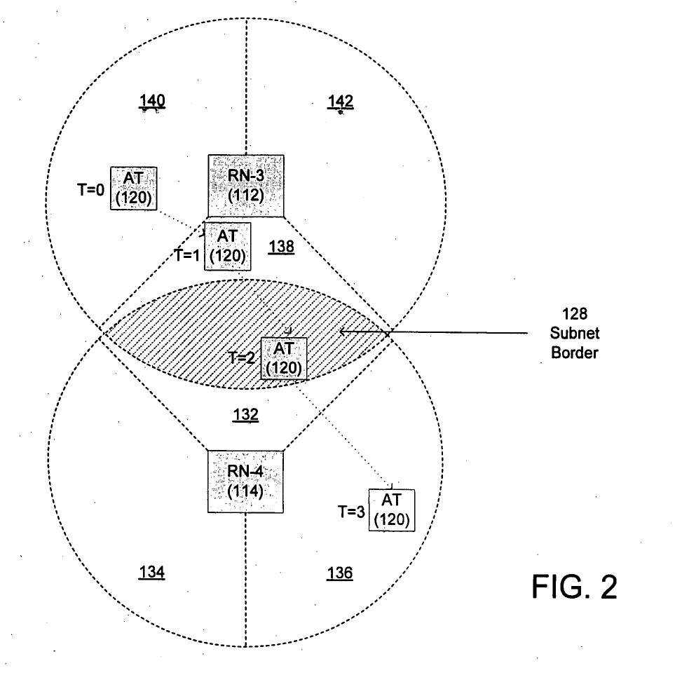

In the illustrated example of FIGS. 1 and 2, the radio nodes RN-3 112 and RN-4 114 are located at or near the subnet boundaries and are 1xEV-DO Rev-B capable radio nodes. As Rev-B is backwards compatible with Rev-0 and Rev-A, any 1xEV-DO access terminal may communicate with a Rev-B radio node regardless of the mode (i.e., Rev-0, Rev-A or Rev-B) the access terminal is operating in or is capable of operating in. During network design, the network operator configures the radio node RN-3 112 (with sectors 138, 140, 142) to have an enhanced border association with the radio node controller RNC-2 104, and configures the radio node RN-4 114 (with sectors 132, 134, 136) to have an enhanced border association with the radio node controller RNC-1 102. The network operator also designates certain sectors as border sectors, for example, each sector having a portion that overlaps a sector of another subnet is designated as a “border sector,” all sectors of a radio node that has a border association with a radio node controller are designated as “border sectors,” or some combination of both.

Each sector (border or non-border) of the radio nodes RN-3 112 and RN-4 114 periodically broadcasts a sector parameters message that includes a sector address identifier provided in a 128-bit SectorID field and a subnet boundary identifier provided in a 1-bit IgnoreSubnetBoundary field. The sector address identifier uniquely identifies the sector, and the subnet boundary identifier identifies the sector's designation as a border or non-border sector. In the example of FIG. 2, the sectors 134, 136, 140, 142 each broadcast a subnet boundary identifier of “0” indicating that the sectors 134, 136, 140, 142 are non-border sectors, and the sectors 132, 138 each broadcast a subnet boundary identifier of “1” indicating that the sectors 132, 138 are border sectors. Rev-B capable access terminals are configured to take a specific action based on whether the subnet boundary identifier is set to “0” or “1” as described below. Rev-A and Rev-0 capable access terminals do not recognize the IgnoreSubnetBoundary field and take no action regardless of whether the subnet boundary identifier is set to “0” or “1”.

The following example scenario involves a dormant Rev-B capable access terminal 120 that has a 1xEV-DO session (“S1”) established on the radio node controller RNC-1 102 at time t=0.

At time t=1, the domant access terminal 120 moves into border sector 138 and compares its UATI with the SectorID of the sector parameters message being broadcasted by the border sector 138. As the UATI falls within the same range as the SectorID, no action is taken by the access terminal. If the dormant access terminal 120 attempts to initiate a communication with the network 100 at this point, the access channel message would be routed through RN-3 112 to the radio node controller with which it has a primary association, that is, RNC-1 102.

At time t=2, the dormant access terminal 120 moves into a region (illustratively depicted in FIG. 2 by hashed marks) of the border sector 138 that overlaps with the border sector 132 of radio node RN-4 114. The dormant access terminal 120 compares its UATI with the SectorID of the sector parameters message being broadcasted by the border sector 132 and recognizes (based on the UATI and the SectorID of border sector 132 being in different ranges) that it has crossed a subnet boundary. The dormant access terminal then examines the “IgnoreSubnetBoundary” field to determine what action, if any, is to be taken. In this case, the bit of the “IgnoreSubnetBoundary” field is set to “1”. The dormant access terminal recognizes that it is in a border sector of a subnet different from the subnet on which its 1xEV-DO session SI is currently established, but does not send a UATI_Request message to the radio node controller RNC-2 104. If the dormant access terminal 120 attempts to initiate a communication with the network 100 at this point, the access channel message would be routed through RN-4 to the radio node controller with which it has an enhanced border association, that is, RNC-1 102. In so doing, a dormant handoff between the radio node controllers RNC-2 104 and RNC-1 102 is avoided, which has the effect of conserving airlink and network resources, while ensuring that the dormant access terminal located in an area that straddles the boundaries or borders between two subnets is able to maintain its network connectivity with the network 100 in rapid mobility cases or in cases in which fast ping-pongs between subnets take place due to poor or changing RF conditions. Generally, a ping-pong is said to occur when a dormant access terminal moves from a coverage area of a first radio node controller to a coverage area of a second radio node controller, and then back to a coverage area of the first radio node controller or onto a coverage area of a third radio node controller.

At time t=3, the dormant access terminal 120 moves into the non-border sector 136 of radio node RN-4 114. The dormant access terminal 120 compares its UATI with the SectorID of the sector parameters message being broadcasted by the non-border sector 136 and recognizes (based on the UATI and the SectorID of border sector 136 being in different ranges) that it has crossed a subnet boundary. The dormant access terminal then examines the “IgnoreSubnetBoundary” field to determine what action, if any, is to be taken. In this case, the bit of the “IgnoreSubnetBoundary” field is set to “0”. The dormant access terminal recognizes that it is in a border sector of a subnet different from the subnet on which its 1xEV-DO session is currently established, and needs to send a UATI_Request message including a foreign UATI (assigned by RNC-1 102) to the radio node controller RNC-2 104. This action triggers the radio node controller RNC-2 104 to initiate an A13 dormant handoff by sending an A13 Request message to the radio node controller RNC-1 102 requesting the session configuration parameters associated with S1. The RNC-1 102 responds to the A13 Request message with an A13 Response message that includes the requested information. Upon receipt of the A13 Response message, the RNC-2 104 uses the session configuration parameters retrieved from the RNC-1 102 to establish a new 1xEV-DO session (“S2”) at RNC-2 104.

Although the techniques described above employ the 1xEV-DO air interface standard, the techniques are also applicable to other CDMA and non-CDMA air interface technologies.

The techniques described above can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

Other embodiments are within the scope of the following claims.

What is claimed is:

1. A method comprising:
in a radio access network including subnets, enabling a radio node of a first subnet to receive a communication over an access channel from an access terminal that is in a dormant state and to send information about the communication to a radio node controller of a second subnet.

2. The method of claim 1, wherein at least one sector of the radio node of the first subnet is at or near a geographic boundary of the first subnet.

3. The method of claim 1, wherein the enabling comprises:
providing access by the radio node to a radio node controller identifier for the radio node controller of the second subnet.

4. The method of claim 3, wherein the radio node controller identifier comprises a colorcode.

5. The method of claim 1, wherein the enabling comprises:
providing the radio node of the first subnet with information sufficient to enable the radio node to identify the radio node controller of the second subnet to which the communication is sent.

6. The method of claim 5, wherein the information comprises a radio node controller identifier for each radio node controller with which the radio node of the first subnet has an association.

7. The method of claim 5, wherein the information comprises a radio node colorcode table.

8. The method of claim 1, wherein the enabling comprises:
examining the communication to determine whether its destination is a radio node controller with which the radio node of the first subnet has an enhanced border association.

9. A method comprising:
in a radio access network including a first subnet and a second subnet, the first subnet and the second subnet being neighboring subnets of the network, enabling a radio node of the first subnet to broadcast an overhead message comprising a subnet boundary identifier.

10. The method of claim 9, wherein the subnet boundary identifier identifies a sector of the radio node as being a border sector or a non-border sector.

11. The method of claim 9, wherein at least one sector of the radio node of the first subnet is at or near a geographic boundary between the first subnet and the second subnet.

12. The method of claim 9, wherein the overhead message comprises a 1xEV-DO sector parameters message, and the subnet boundary identifier comprises one or more bits of a IgnoreSubnetBoundary field.

13. The method of claim 9, wherein the overhead message further comprises a sector identifier.

14. The method of claim 13, wherein an action is taken by an access terminal having a session on a radio node controller of the second subnet when both the sector identifier identifies the access terminal as being in a coverage area of the first subnet and the subnet boundary identifier identifies a serving sector as being a non-border sector.

15. The method of claim 14, wherein the action comprises sending a Universal Access Terminal Identifier (UATI) Request message of the IS-856 standard through the radio node of the first subnet to the radio node controller of the first subnet.

16. The method of claim 9, wherein no action is taken by an access terminal having a session on a radio node controller of the second subnet when both the sector identifier identifies the access terminal as being in a coverage area of the first subnet and the subnet boundary identifier identifies a serving sector as being a border sector.

17. A radio access network comprising:
a first subnet comprising a first radio node controller and a first radio node; and
a second subnet comprising a second radio node controller,
wherein the first radio node has an association with the second radio node controller that enables the first radio node to receive a communication over an access channel from an access terminal in a dormant state and to send the communication to the second radio node controller.

18. The network of claim 17, wherein the first subnet and the second subnet are neighboring subnets.

19. The network of claim 17, wherein the first radio node is configured to broadcast an overhead message comprising a subnet boundary identifier.

20. The network of claim 19, wherein the subnet boundary identifier identifies a sector of the first radio node as being a border sector or a non-border sector.

21. The network of claim 17, wherein the first radio node has a radio node colorcode table that identifies colorcode assignments for radio node controllers with which the first radio node is associated.

22. The network of claim 17, wherein the first radio node controller examines the communication received over the access channel from the access terminal in the dormant state, and identifies a destination of the communication based on the examination.

23. The network of claim 17, wherein the first radio node has an association with the second radio node controller that enables the access terminal to maintain its session on the second radio node controller as the access terminal moves from a coverage area of the second subnet to a first coverage area of the first subnet.

24. The network of claim 23, wherein the first coverage area of the first subnet comprises a border sector of the first radio node.

25. An apparatus comprising:
in a radio access network including subnets, means for enabling a radio node of a first subnet to receive a communication over an access channel from an access terminal that is in a dormant state and to send information about the communication to a radio node controller of a second subnet.

26. The apparatus of claim 25, wherein the means for enabling comprises:
means for providing access by the radio node to a radio node controller identifier for the radio node controller of the second subnet.

27. The apparatus of claim 26, wherein the radio node controller identifier comprises a colorcode.

28. An apparatus comprising:
in a radio access network including a first subnet and a second subnet, the first subnet and the second subnet being neighboring subnets of the network, means for enabling a radio node of the first subnet to broadcast an overhead message comprising a subnet boundary identifier.

29. The apparatus of claim 28, wherein the subnet boundary identifier identifies a sector of the radio node as being a border sector or a non-border sector.

30. The apparatus of claim 28, wherein at least one sector of the radio node of the first subnet is at or near a geographic boundary between the first subnet and the second subnet.

31. The apparatus of claim 28, wherein the overhead message comprises a 1xEV-DO sector parameters message, and the subnet boundary identifier comprises one or more bits of a IgnoreSubnetBoundary field.
